(19) United States
(12) Patent Application Publication
(10) Pub. No.: US 2011/0028077 A1
(43) Pub. Date: Feb. 3, 2011

(54) HEADLINER DUCT

(75) Inventors: Adam Michael Ludwig, Ann Arbor, MI (US); Donald Federico, Grass Lake, MI (US); Yan Liu, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/510,752

(22) Filed: Jul. 28, 2009

(51) Int. Cl. B60H 1/24

(52) U.S. Cl. 454/143

(57) ABSTRACT

A headliner duct for a heating-venting-air conditioning (HVAC) system in a motor vehicle is provided. The headliner duct can include a headliner and an elongated thermoformed aircap that has a wall and is bonded to a top side of the headliner. The thermoformed aircap and the headliner form an air duct, the air duct having an inlet and being operable to have an air flow pass therethrough. The elongated thermoformed aircap has an air-kick that is integral with the wall of the aircap and extends into an air flow region thereof.

### FIELD OF THE INVENTION

The present invention is related to a headliner duct for a heating-venting-air conditioning (HVAC) system in a motor vehicle, and in particular to a headliner duct containing a thermoformed aircap with an air-kick that diverts at least part of an air flow past a first register to a second register.

### BACKGROUND OF THE INVENTION

The placement of heating-venting-air conditioning (HVAC) ducting within or above a headliner in a motor vehicle is known. Such HVAC ductwork is typically used to direct air flow to different portions of an interior of the motor vehicle and yet remain out of sight to individuals riding therein. In addition, HVAC ducts have traditionally been made using blow molding of polymers to form complete or integral elongated ducts.

Recent developments in manufacturing processing of polymers have resulted in a process known as thermoforming. This process involves placing a heated panel or layer of polymer material into contact with a die and forming and/or pressing the layer of material over the die to form a desirably shaped and/or contoured component. Thermoforming is particularly well suited for the production of prototype parts, however, the process does have the limitation of draft angles on a formed component having to generally greater than 8 to 10 degrees, whereas standard blow molding requires draft angles having to be generally greater than 2 to 3 degrees. As such, advances in component design, shape, contour, etc., have been limited.

The desired distribution of flowing air to a particular compartment within a motor vehicle can be difficult to achieve due to a variety of interior and/or exterior design criteria. In addition, the use of materials and processes that afford for reduced weight and cost is always desired and thermoformed components can provide a weight and/or cost savings. However, the heretofor use of thermoforming for HVAC ductwork has resulted in limited shapes and/or designs of the ducts, and at times, undesirable air flow delivery to one or more motor vehicle interior compartments. Therefore, a thermoformed duct that provides desired air flow to various compartments within the interior of the motor vehicle would be desirable.

### SUMMARY OF THE INVENTION

A headliner duct for a heating-venting-air conditioning (HVAC) system in a motor vehicle is provided. The headliner duct can include a headliner and an elongated thermoformed aircap that has a wall and is bonded to a top side of the headliner. The thermoformed aircap and the headliner form an air duct, the air duct having an inlet and being operable to have an air flow pass therethrough.

The headliner has a bottom side with a first register and a second register spaced apart from the first register. The first register and the second register are in fluid communication with the air duct, and the first register can be located downstream from the second register and the second register can be located downstream from the inlet. The elongated thermoformed aircap has an air-kick that is integral with the wall of the aircap and extends into an air flow region of the duct. The air-kick can be located upstream from the second register and is operative to divert at least part of the air flow past the second register to the first register.

In some instances, the wall of the elongated thermoformed aircap is a sidewall and the air-kick extends from the sidewall into the air flow region of the air duct. The air-kick can divert between 5 to 35 volume percent of the air flow past the second register to the first register, or in the alternative, the air-kick can divert between 10 to 30 volume percent of the fluid flow past the second register to the first register. In still another alternative, the air kick can divert between 15 to 25 volume percent of the fluid flow past the second register to the first register.

The elongated thermoformed aircap can be a multilayered component with a substrate having an outer surface and an inner surface, and an air non-permeable layer extending across and attached to the outer surface and/or the inner surface. In some instances, the substrate can contain and/or be made of expanded polypropylene foam, whereas the air non-permeable layer can contain and/or be made from polyethylene.

### BRIEF DESCRIPTION OF THE DRAWINGS

FIG. 1 is a side view of a motor vehicle illustrating air flow from a headliner of the motor vehicle to separate compartments therewithin;

FIG. 2 is a top perspective view of a headliner duct for a heating-venting-air conditioning system of the motor vehicle shown in FIG. 1;

FIG. 3 is an end cross-sectional view of the section 3-3 shown in FIG. 2;

FIG. 3a is an enlarged view of the circled region 3a shown in FIG. 3;

FIG. 4 is a top cross-sectional view illustrating a thermoformed aircap duct in a headliner with air flowing to a second register and a first register; and

FIG. 5 is a top cross-sectional view of a thermoformed aircap duct having an air-kick that diverts air past a second register to a first register.

### DETAILED DESCRIPTION OF THE INVENTION

The present invention discloses a headliner duct for a heating-venting-air conditioning (HVAC) system in a motor vehicle. As such, the headliner duct has utility as a component for a motor vehicle.

The headliner duct can include a headliner and an elongated thermoformed aircap that has a wall and is attached to a top side of the headliner. For the purposes of the present invention, the term “aircap” is defined as a generally channel-shaped structure having an open side that can be bonded, attached, etc. to a headliner in order to form an air flow passage between the headliner and the channel-shaped structure. The term “thermoformed” is defined as a component made by a thermoforming process. The elongated thermoformed aircap and the headliner can form an air duct having an inlet, the air duct operable for air to pass or flow therethrough.

The headliner can have a bottom side with a first register and a second register spaced apart from the first register. It is appreciated that the first register and the second register can afford for air flowing through the headliner duct to be supplied to different compartments, regions, etc. within an interior of the motor vehicle. As such, the first and second registers are in fluid communication with the air duct. The first register can be located downstream from the second register and the second register can be located downstream from the inlet. In this manner, air from a heating unit, air conditioning unit and the like can be supplied to desired locations within the interior of the motor vehicle.

In some instances, the elongated thermoformed aircap can have an air-kick that is integral with the wall of the aircap and extends into an air flow region of the air duct. For the purposes of the present invention, the term “air-kick” is defined as a structure that can divert, control, etc. air flowing within the air duct. The air-kick can be located upstream from the second register and be operative to divert at least part of the air flow past the second register to the first register.

In some instances, the wall of the elongated thermoformed aircap is a sidewall, and the air-kick extends in a generally sideward direction into the air flow region of the air duct. The air-kick can divert between 5 to 35 volume percent of air flow past the second register to the first register. In the alternative, the air-kick can divert between 10 to 30 volume percent of the air flow past the second register to the first register, while in another alternative, the air-kick can divert between 15 to 25 volume percent of the air flow past the second register to the first register.

It is appreciated that the elongated thermoformed aircap can provide a cost and/or weight savings compared to a standard blow molding air duct. In some instances, the elongated thermoformed aircap is a multilayered component having a substrate and at least one air non-permeable layer. The substrate can have an outer surface and an inner surface, the outer surface and/or inner surface having the air non-permeable layer extending thereacross and being attached thereto. The substrate and the air non-permeable layer can be made from any polymeric material known to those skilled in the art. For example and for illustrative purposes only, the substrate can contain and/or be made from expanded polypropylene foam and the air non-permeable layer can contain and/or be made from polyethylene. In this manner, a headliner having an attached elongated thermoformed aircap can provide an air duct for a motor vehicle that reduces cost and savings compared to heretofore headliner air ducts, and still provide a desired amount of air flow to various compartments within the interior of the motor vehicle.

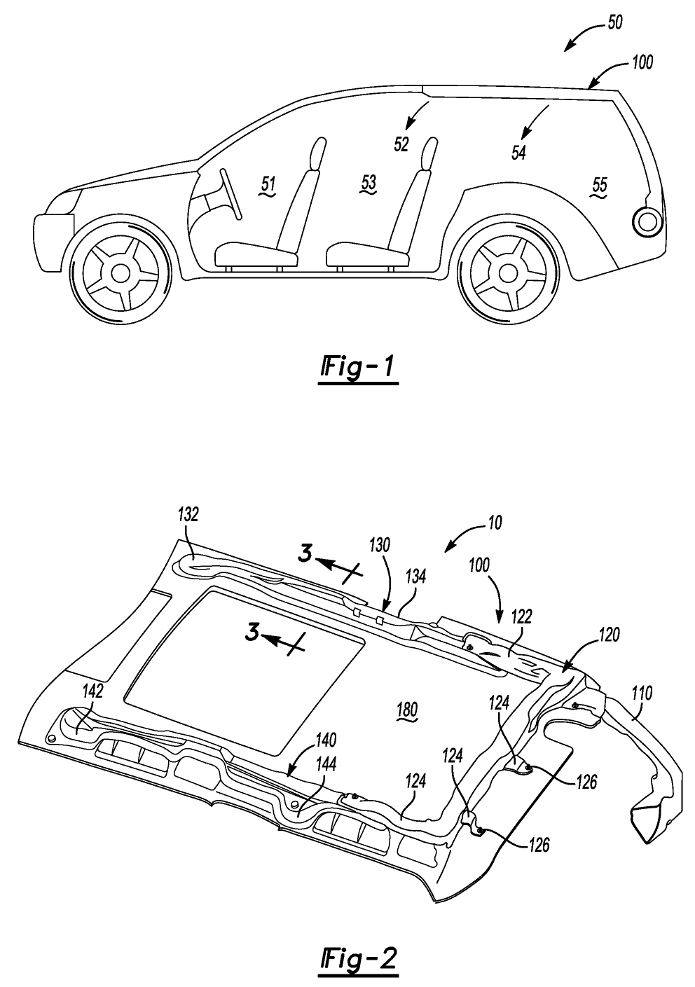

Turning now to FIG. 1, a side view of a motor vehicle is shown generally at reference numeral 50. The motor vehicle 50 can have a number of different spaces/compartments such as a front row seat compartment 51, a second row seat compartment 53, and a third rearward compartment 55. In addition, the motor vehicle 50 can supply air using one or more registers in order to provide comfort to one or more individuals within the motor vehicle. As shown in FIG. 1, air can flow from ductwork 100 to a location 52 and a location 54 in order to provide heated or cooled air to the second row passenger compartment 53 and/or the rearward compartment 55.

Turning now to FIG. 2, an embodiment of a headliner duct for an HVAC system is shown generally at reference numeral 10. The headliner duct 10 can include the ductwork 100 and a headliner 180. The ductwork 100 can include an inlet duct 110 and a transition duct 120. The transition duct 120 may or may not be a blow-molded duct and can have a first passageway 122 and a second passageway 124. The transition duct 120 can also have one or more brackets 125 with fasteners 126 that afford for the duct 120 to be attached to the headliner 180. It is appreciated that the first passageway 122 and the second passageway 124 afford for air provided through the inlet 110 to be routed to different sides of the motor vehicle and may or may not be generally mirror images of each other.

The first passageway 122 can be connected to a first elongated thermoformed aircap 130, and the second passageway 124 can be connected to a second elongated thermoformed cap 140. It is appreciated that the first and second passageways 122, 124 are in fluid communication with the first and second thermoformed aircaps 130, 140, respectively. In addition, the first and second thermoformed aircaps 130, 140 can have a first register region 132, 142 and a second row register region 134, 144 that are located proximate to and in fluid communication with a first row of registers (not shown) and a second row of registers (not shown), respectively, that are within the headliner 180. It is appreciated that the registers afford for air to flow from the ductwork 100 into the interior of the motor vehicle 50.

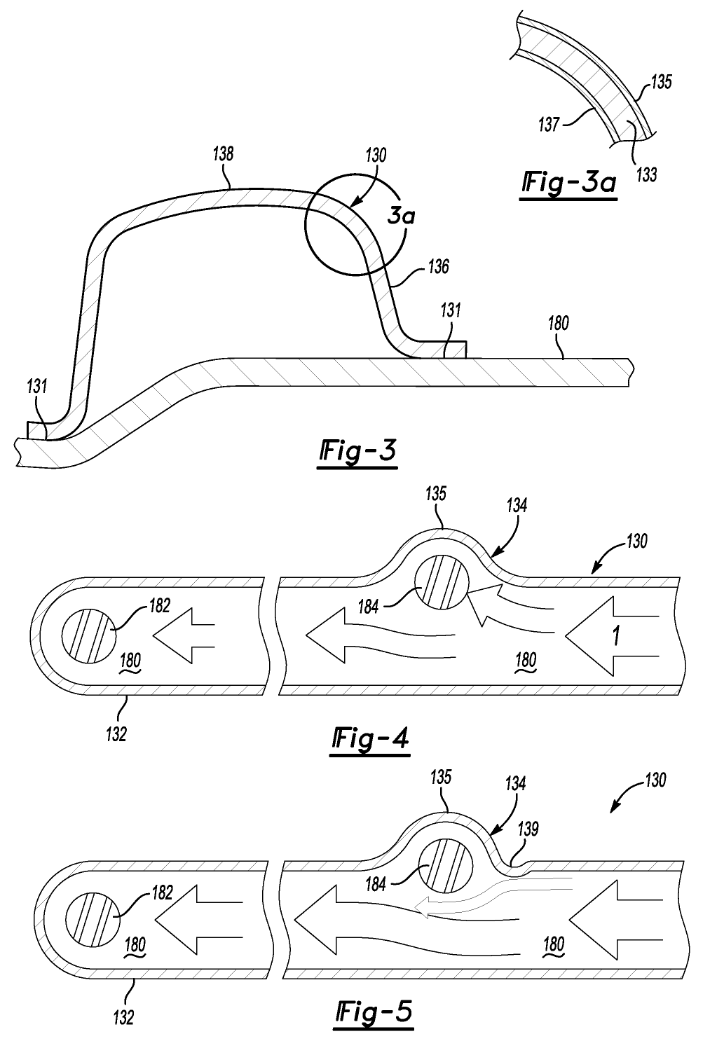

Turning now to FIG. 3, an end cross-sectional view of the section 3-3 in FIG. 2 is shown. The elongated thermoformed aircap 130 can have a sidewall 136 and a top wall 138. The end cross section is generally channel shaped and thus provides for an air passageway between the aircap 130 and the headliner 180. The aircap 130 can be bonded to the headliner 180 at 131 using adhesives, welding, fasteners, and the like. It is appreciated that the bonding of the aircap 130 to the headliner 180 can be an airtight seal. In addition, the aircap 130 can be a multilayer component having a substrate 133 and at least one air non-permeable layer 135 or 137. The at least one air non-permeable layer can extend across and/or be attached to an outer surface and/or an inner surface of the substrate 133. As such, in some instances the substrate 133 can have a first air non-permeable layer 135 attached to an outer surface thereof and/or a second air non-permeable layer 137 attached to an inner surface.

Looking now at FIG. 4, the elongated thermoformed aircap 130 extend can across a first register 182 and a second register 184 that are within the headliner 180. It is appreciated that the terms “first register” and “second register” are used for descriptive purposes only and as such, the register 182 could in fact be known as a second register and the register 184 could be known as a third register within the motor vehicle. As shown in FIG. 4, flowing air supplied to the air duct and indicated by arrow 1 can be split between exiting the second register 184 and the first register 182. In this manner, air flowing through the air duct formed by the aircap 130 bonded to the headliner 180 can be supplied to the passenger compartment 53 and passenger compartment 55.

In some instances, it is desired that more air be supplied to the second row passenger compartment 53 than to the third rearward compartment 55. In such instances, an air-kick 139 can be located upstream of the second register 184 as shown in FIG. 5. The air-kick 139 can divert at least part of the air flow symbolized as arrow 1 from the second register 184 to the first register 182. In addition, the air-kick 139 can divert air flow that would normally exit the second register 184 shown in FIG. 4 to the first register 182.

It is appreciated that the air-kick 139 is integral with the sidewall 136 and thus does not require additional parts to provide desired air flow between the two registers 182, 184. In some instances, the air-kick 139 can extend along the entire height of the sidewall 136, or in the alternative, extend along only a portion of the height of the sidewall 136. In addition, the air-kick 139 can divert between 5 to 35 volume percent of the air flow symbolized by the arrow 1 past the second register 184 to the first register 182. In the alternative, the air-kick 139 can divert between 10 to 30 volume percent past the second register 184 to the first register 182, while in another alternative, the air-kick 139 can divert between 15 to 25 volume percent of the air flow. In this manner, a single elongated thermoformed aircap is provided that affords for desired air flow to exit a first register 182 and a second register 184 that is within a headliner 180 of a motor vehicle.

It is appreciated that the second elongated thermoformed aircap 140 can have identical and/or similar properties, shapes, and the like as the first elongated thermoformed aircap 130 such that a desired air flow to a first and second register located proximate to the first register region 142 and the second register region 144, respectively, can be provided. As such, an air-kick that is integral with a sidewall of the second elongated thermoformed aircap 140 can be provided such that 5 to 35 volume percent, 10 to 30 volume percent, or 15 to 25 volume percent of the air flow provided to the aircap 140 is diverted from a second register to a first register.

The foregoing drawings, discussion, and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

1. A headliner duct for an HVAC system in a motor vehicle, said headliner duct comprising:
a headliner;
an elongated thermoformed aircap having a wall and bonded to a top side of a headliner, said thermoformed aircap and said headliner forming an air duct, said air duct having an inlet and operable to have an air flow pass therethrough;
said headliner having a bottom side with a first register and a second register spaced apart from said first register, said first and second registers in fluid communication with said air duct, and said first register located downstream said second register and said second register located downstream said inlet;
said elongated thermoformed aircap having an air-kick integral with said wall and extending into an air flow region of said air duct, said air-kick located upstream said second register and operative to divert at least part of the air flow past said second register to said first register.

2. The headliner duct of claim 1, wherein said wall is a sidewall.

3. The headliner duct of claim 1, wherein said air-kick diverts between 5 to 35 volume percent of the air flow past said first register to said second register.

4. The headliner duct of claim 3, wherein said air-kick diverts between 10 to 30 volume percent of the air flow past said first register to said second register.

5. The headliner duct of claim 4, wherein said air-kick diverts between 15 to 25 volume percent of the air flow past said first register to said second register.

6. The headliner duct of claim 1, wherein said elongated thermoformed aircap is a multilayered component.

7. The headliner duct of claim 6, wherein said multilayered component has a substrate with an outer surface and an inner surface, an air non-permeable layer extending across and attached to said outer surface and an air non-permeable layer extending across and attached to said inner surface.

8. The headliner duct of claim 7, wherein said substrate contains expanded polypropylene foam.

9. The headliner duct of claim 7, wherein said air non-permeable layer contains polyethylene.
